(19) United States
(12) Patent Application Publication
(10) Pub. No.: US 2016/0140584 A1
(43) Pub. Date: May 19, 2016

(54) EMD-Spectral Prediction (ESP)

(71) Applicant: eBay Inc., San Jose, CA (US)

(72) Inventor: Azadeh Moghtaderi, San Jose, CA (US)

(21) Appl. No.: 14/542,772

(22) Filed: Nov. 17, 2014

(51) Int. Cl. G06Q 30/02

(52) U.S. Cl. CPC G06Q 30/0202

(57) ABSTRACT

A data prediction method to apply to a time series. In some embodiments, the data may be decomposed into a superposition of two or more components, which each represent different facets of the data. In further embodiments presented herein, the data may be decomposed into components representing: slowly-varying oscillations; cyclical and known instantaneous (non-stationary) disturbances; and background stationary noise effects. Each component may then be subjected to its own prediction algorithm. The predicted values of each component may then be composed to obtain a final prediction of the original data.

### TECHNICAL FIELD

The present application relates generally to the technical field of data processing, and, in one particular embodiment, to systems and methods of providing an adaptive prediction model flexible enough to apply to virtually any time series data set.

### BACKGROUND

Predictive modeling is the process by which a model is created to try to best forecast probabilities and trends. Desirable properties of a prediction model should include the flexibility to apply to any data set; the capability to automatically adapt to each data set without manual tuning or operator oversight; the capability to address any non-stationarity issues in a data set; and the capacity to run on billions of data sets in a short period of time.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram of an example system, according to various embodiments;

FIG. 3 is a flow diagram illustrating a method for determining a final prediction, \hat{X}ₜ₊₁ through modeling of the individual components of the decomposed data set;

FIG. 4 is a flow diagram illustrating a method for identifying and modeling slowly varying oscillations within a time series;

FIG. 5 is an illustration of an estimation of the slowly varying term modeled using Empirical Mode Decomposition (EMD) trend filtering method;

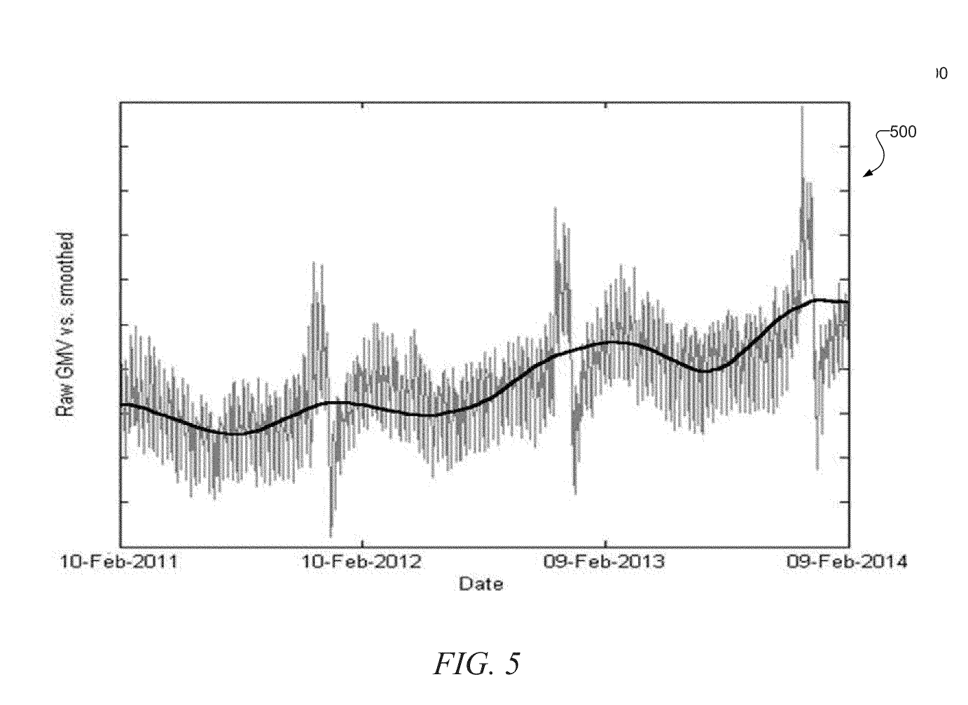

FIG. 6 is a flow diagram illustrating a method of modeling data associated with cyclical and known instantaneous events;

FIG. 7 is a flow diagram illustrating a method of modeling background noise and combining prediction data to obtain a final prediction for a time series;

FIG. 8 is a diagrammatic representation of a machine in the example form of a computer system within which a set of instructions may be executed to cause the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

According to various exemplary embodiments described herein, an adaptive prediction model is configured to make predictions based on data associated with a time series, {Xₜ}. For example, the adaptive prediction model may make a one step prediction \hat{X}ₜ₊₁, based on the historic data associated with the time series {Xₜ}. For purposes of clarification, a time series is a sequence of data points, measured typically at successive points in time.

Desirable properties of a prediction model include the flexibility to apply to virtually any data set; a capability to automatically “adapt” to each data set without manual tuning or operator oversight; the capability to address issues pertaining to non-stationarity in data, wherein the statistical behavior of a data set varies in time; and the capacity to run on billions of data sets in a short time period. The present disclosure is directed to Empirical Mode Decomposition (EMD)—Spectral Prediction (ESP). EMD-spectral prediction (ESP), an adaptive prediction model configured to make predictions based on a provided time series without manual tuning or operator oversight, through a novel approach. According to a particular exemplary embodiment described herein, ESP may include various component modules including source modules configured to obtain a time series from various sources of data, decomposing modules that decompose the time series into a superposition of three components, a selection module which determines which prediction algorithm to apply to each of the components, and a prediction module which determines a final prediction for the time series, with no “hand-tuning” or choosing of parameters by an operator.

A useful property of many real-world time series, briefly referenced above, is that they may exhibit a “composite” behavior, in the sense that such a time series can be decomposed into a superposition of two or more “components.” As described in various embodiments, an ESP system may be configured to decompose a specified time series, and assign parameter-dependent or non-parametric classifications to each component. This classification is desirable, as each component may exhibit different properties to which different prediction algorithms may be applied to provide an accurate and useful model. As such, in some embodiments a time series may be decomposed into a superposition of three components. These components may be classified as slowly varying oscillations, cyclical and known instantaneous (non-stationary) events, and lastly the residual or background stationary noise. By applying an appropriate predication algorithm to each component of the time series, and combining the resulting predictions, a more accurate overall prediction for the time series may be determined.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions. ESP may be used to generate predictions with a broad range of applications. In some embodiments consistent with the methods disclosed herein, the ESP adaptive prediction model may be applied to time series of various resolutions to generate corresponding predictions which may include: hourly predictions; daily predictions; quarterly predictions; as well as annual predictions. In further embodiments, ESP may be used for anomaly detection. For example, ESP may be applied to a time series, {Xₜ}, where {Xₜ} comprises data corresponding to an online marketplace and comprises actual real-world data. ESP may then generate a prediction, \hat{X}ₜ₊₁ based on the time series {Xₜ}. The ESP system may be further configured to compare the corresponding prediction value for Xₜ₊₁, jeₜ₊ᵢ , to the actual value of Xₜ₊₁, and in doing so, determine if there are any anomalies corresponding to the time series data {Xₜ}. The presence of anomalies may then be used to evaluate the health of the overall system generating Xₜ₊₁.

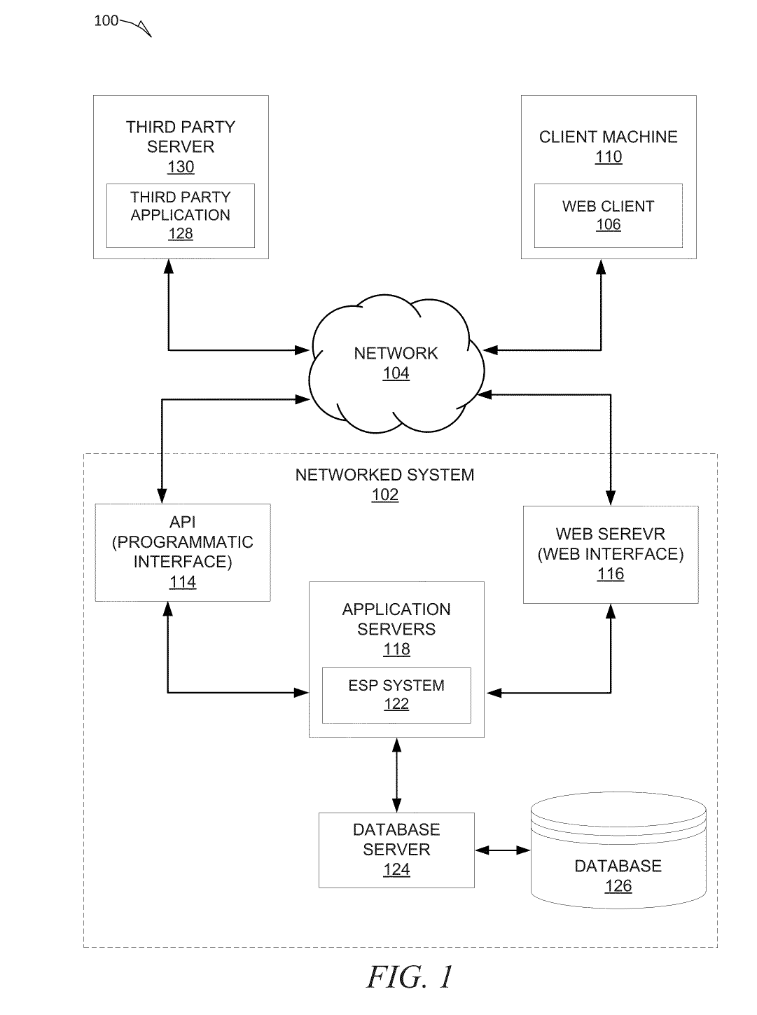

FIG. 1 is a network diagram depicting a client-server system 100 within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Google Chrome browser developed by Google Inc. of Mountain View, Calif.) executing on client machine 110.

An API server 114 and a web server 116 are coupled to, and provide programmatic and web interfaces respectively to, one or more application servers 118. The application servers 118 host an ESP System 122. The application servers 118 are, in turn, shown to be coupled to one or more database servers 124 that facilitate access to one or more databases 126.

The ESP System 122 may provide predictive functions to users who access the networked system 102. While the ESP System 122 is shown in FIG. 1 to form part of the networked system 102, it will be appreciated that, in alternative embodiments, the ESP System 122 may form part of a predictive system that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The ESP System 122 could also be implemented as standalone software programs, which do not necessarily have networking capabilities.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more promotional, marketplace, or payment functions that are supported by the relevant applications of the networked system 102.

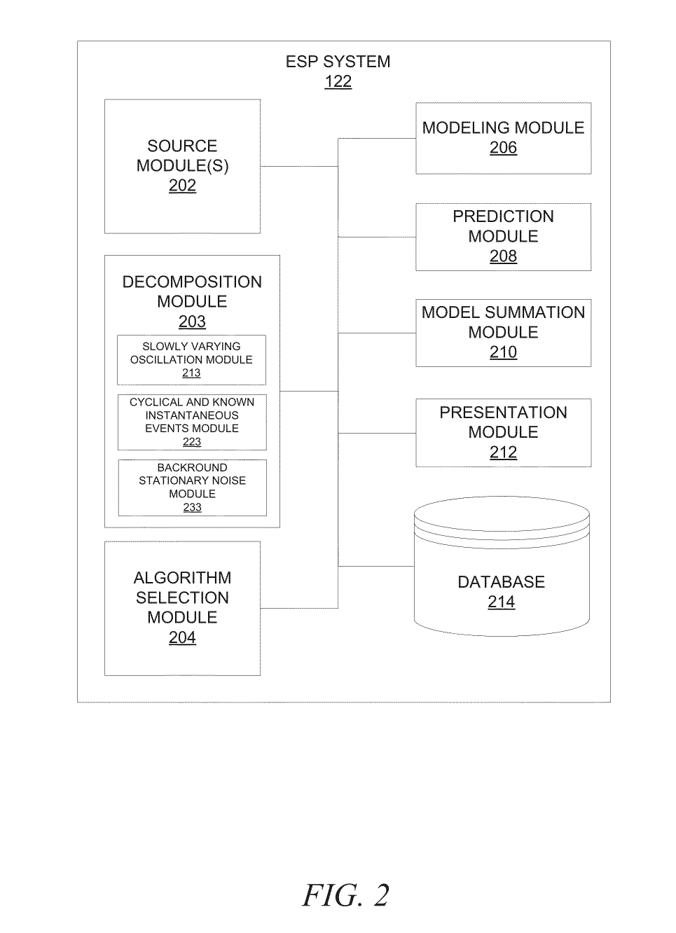

Turning now to FIG. 2, an ESP system 122 includes one or more source modules 202; one or more decomposition modules 203, which may include a slowly varying oscillation module 213, a cyclical and known instantaneous events module 223, and a background stationary noise module 233; an algorithm selection module 204; a modeling module 206; a prediction module 208; a model summation module 210; a presentation module 212; and a database module 214. The modules of the ESP system 122 may be implemented on or executed by a single device, or on separate devices interconnected via a network. The aforementioned ESP device may be, for example, a client machine or application server.

The source module 202 may be configured to access a configuration file that identifies a time series corresponding to data gathered from external data sources. The data may include a simulated time series containing different types of trend, as well as real-world data, which may correspond to any source of data including user clicks on a web-site, to atmospheric carbon dioxide levels, as well as items bought in an online marketplace. In some embodiments, the source module may be further configured to deliver the corresponding time series to the decomposition module 203.

The decomposition module 203 may be configured to decompose a time series gathered by the source module 202, into a superposition of components. In some embodiments, the decomposition module 203 may be comprised of: a slowly varying oscillation module 213, configured to identify slowly varying oscillations; a cyclical and known instantaneous events module 223, configured to identify cycles and known instantaneous events; and a background stationary noise module 233, configured to identify stationary background noise. Responsive to receiving a time series from the source module 202, the decomposition module 203 may be configured to allocate an appropriate internal module 213, 223, or 233, which may then identify and remove the corresponding components from the time series. The decomposition module 203 may then deliver the decomposed time series to the algorithm selection module 204.

The algorithm selection module 204 may be configured to select an appropriate estimation and prediction algorithm to apply to each component of the decomposed time series. In some embodiments, a different estimation and prediction algorithm may be applied to each component of the decomposed time series. A non-parametric model may be used to estimate a particular term, while a different model may be used for prediction. For example, while EMD which is a non-parametric algorithm may be used to estimate the slowly varying oscillations, cubic spline may be used to model what was estimated in non-parametric terms. Upon determining an appropriate estimation and prediction algorithms, the algorithm selection module 204 may then deliver the decomposed time series to the modeling module 206.

The modeling module 206 may be configured to generate a corresponding model to each component of the decomposed time series, based on the selection made by the algorithm selection module 204. For example, the modeling module 206 may generate a non-parametric model to represent slowly varying oscillations; a model for the cyclical and known instantaneous events with Multiple Linear Regression (MLR); and a model for the background stationary noise using an autoregressive (AR) model. The modeling module 206 may be further configured to deliver the generated models to the prediction module 208. The prediction module 208 may be configured to extrapolate the models generated by the modeling module 206, in order to obtain a component prediction. In some embodiments consistent with the disclosed method, the estimation and prediction approaches are not the same for the slowly varying oscillation term. The prediction module 208 may be further configured to deliver the extrapolated components to the model summation module 210, where a final prediction for the time series obtained by the source module 202 may be generated.

The model summation module 210 may be configured to generate a final, overall prediction for a time series, by determining the sum of the models corresponding to its individual components. The model summation module 210 may be further configured to deliver the final prediction to the presentation module 212, in order to present the final prediction model to the user.

According to various exemplary embodiments described below, the operation of the ESP system 122 and each of the modules therein may be controlled by a user specified configuration file. The configuration file may be stored locally at, for example, the database 214 illustrated in FIG. 2, or may be stored remotely at a database, data repository, storage server, etc., that is accessible by the ESP system 122 via a network (e.g., the Internet). The configuration file may be any type of electronic file or document written in any type of computer programming language, such as an electronic file written in JavaScript Object Notation (JSON) or eXtensible Markup Language (XML). The configuration file may include at least information (e.g., instructions, code, or labeled fields) describing the configuration and operation of each of the source modules 202; each of the decomposition modules 203, which may include a slowly varying oscillation module 213, a cyclical and known instantaneous events module 223, and a background stationary noise module 233; each of the algorithm selection modules 204; each of the modeling modules 206; each of the prediction modules 208; each of the model summation modules 210; and each of the presentation modules 212.

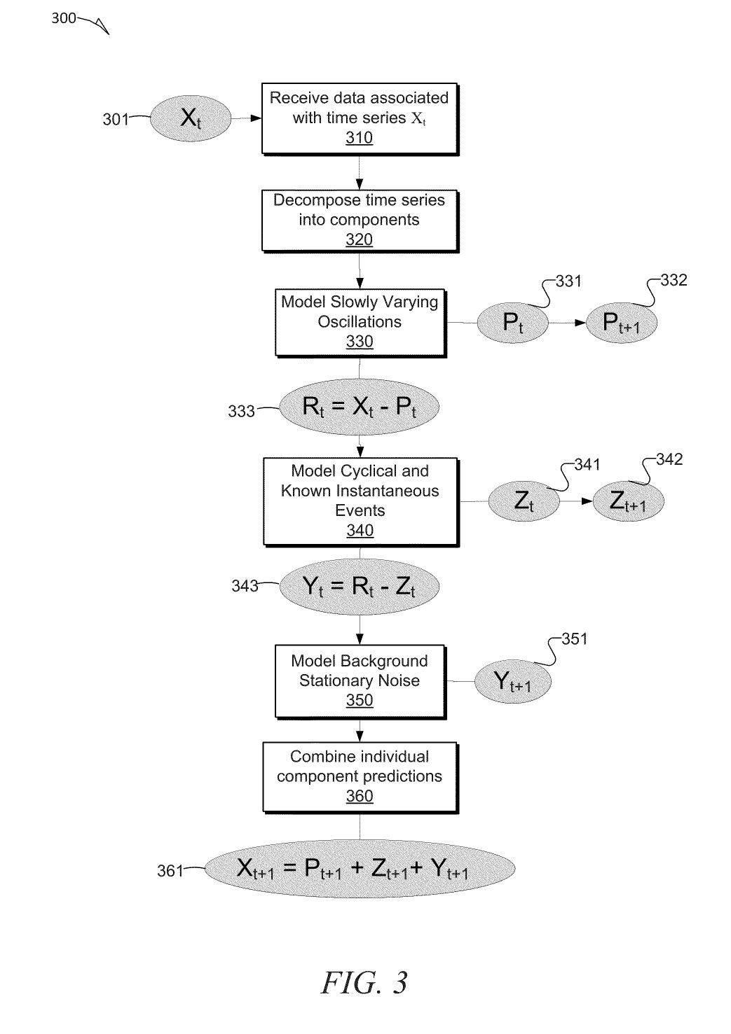

FIG. 3 is a flowchart illustrating a broad overview of an example method 300, according to various exemplary embodiments, for an adaptive prediction model. The method 300 may be performed at least in part by, for example, the ESP system 200 illustrated in FIG. 2 (or an apparatus having similar modules). Operations 310 to 360 will now be described briefly.

In operation 310, the source module 202 may access a configuration file that identifies a time series 301, accessible via external data sources. Time series are frequently plotted via line charts, and are often used in statistics, signal processing, economics, and largely in any domain of applied science and engineering which involves temporal measurements. The source module 202 may then deliver the time series 301 to the decomposition modules 203.

At operation 320, the decomposition modules 203 may decompose the time series 301 into a superposition of components. The decomposition module 203 may first identify the superposition of components which together make up the time series 301. In some embodiments, a specialized module may be used to identify and separate each component of the time series 301. These may include a component representing slowly varying oscillations which may be decomposed and separated by the slowly varying oscillation module 213, a component representing cyclical and known instantaneous events which may be decomposed and separated by the cyclical and known instantaneous events module 223, and a component representing the stationary background noise within the time series 301 which may be decomposed and separated by the background stationary noise module 233. In response to the time series 301 being decomposed into a superposition of components, the algorithm selection module 204 assigns an appropriate estimation and prediction algorithms to each individual component for modelling.

At operation 330, the slowly varying oscillations are identified and modeled by the slowly varying oscillations module 213 using Empirical Mode Decomposition (EMD). A model 331 is created representing the slowly varying oscillations. A prediction 332 for the slowly varying oscillations is obtained through extrapolation of the model 331. The data associated with the model 331 is then removed from the time series 301, resulting in a residual 333.

At operation 340, after the residual 333 is received, the component associated with cyclical and known instantaneous disturbances is identified and modeled by the cyclical and known instantaneous events module 223. A model 341 is created representing the cyclical and known instantaneous disturbances. A prediction 342 for the cyclical and known instantaneous disturbances is obtained. In some embodiments, the prediction 342 may be obtained through Multiple Linear Regression techniques applied to the model 341. The data associated with the model 341 is then removed from the residual 333, resulting in the remaining stationary background noise 343.

At operation 350, the stationary background noise 343 may be modeled and predicted by the stationary background noise module 233, resulting in a prediction 351. At operation 360, the individual predictions 332, 342, and 351 may be combined to create an accurate final prediction 361 based on the time series 301, by the model summation module 210. Each of the aforementioned operations 310 to 360 of the ESP system 200, and each of the aforementioned modules of the ESP system 200, will now be described in greater resolution.

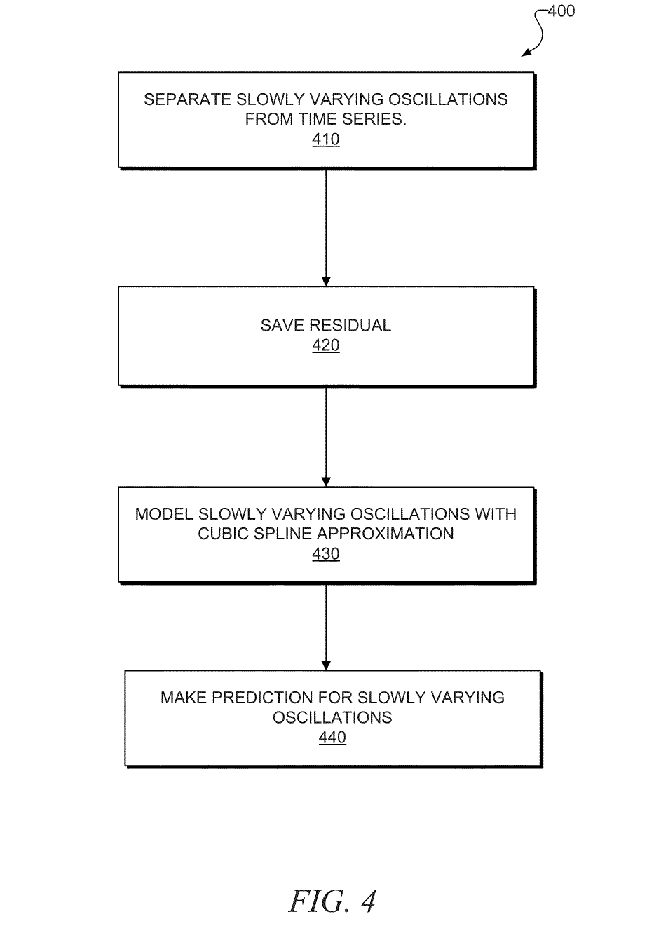

FIG. 4 presents a flowchart illustrating a method 400 for the identification and modeling of slowly varying oscillations from a given time series, as was briefly illustrated in FIG. 3. Slowly varying oscillations in a time series may represent data associated with seasonality and gradual trends. At operation 410, slowly varying oscillations are identified and separated from the time series through the use of Empirical Mode Decomposition (EMD). A challenge associated with effecting such decomposition and classifying the resulting components is called the trend filtering problem. An initial barrier to solving this problem is that the terms “decomposition” and “slowly varying oscillation” are context-dependent. A possible approach to solving the trend filtering problem is to make an ad hoc definition for the slowly varying oscillations. However, such definitions may require an operator to make extra assumptions concerning the nature of the time series, requiring a greater amount of operator oversight, and reducing the overall accuracy of the model. An automated method is therefore proposed to filter the trend in a time series, whose principle is to extract the slowly varying oscillations through EMD. As such, the automated method proposed does not require manual tuning or operator oversight.

EMD is an algorithm which decomposes a time series into an additive superposition of components in order to determine a corresponding trend. The trend may also be described as a slowly varying oscillation. The basic idea is that components of a time series are computed subject to two criteria: First, the number of local extrema and the number of zero crossings of each component vary by at most one. Second, the mean of the upper and lower envelopes of each component should be identically equal to zero, where the envelopes are computed by means of a fixed interpolation scheme. Each component is therefore computed by means of an iterative scheme. This scheme depends on a stopping criterion which guarantees that the criteria above are satisfied within a given tolerance while at the same time each extracted component is meaningful in both amplitude and frequency modulations. Reference is made to the following article, which provides a more detailed explanation of the EMD algorithm:
Huang, N. E. et al. (1998). “The Empirical Mode Decomposition and the Hilbert Spectrum for Nonlinear and Nonstationary Time Series Analysis.” Proceedings of the Royal Society of London A, 454, 903-995.

Once the components of the time series have been identified, the specific components representing the slowly varying oscillations may then be selected. Because the successive components are oscillations going from high frequency to low frequency, the slowly varying oscillations may be written as the sum of the last “few” components and the residual extracted from the time series. Reference is made to the following article, which provides a proposed technique to automatically determine how many components have to be used for a slowly varying trend:
Moghtaderi, A.; Flandrin, P. ; Borgnat, P. (2013) “Trend filtering via empirical mode decompositions.” Computational Statistics and Data Analysis, 58, 114-126.

Referring back to FIG. 4, at operation 420, after the slowly varying oscillations from the time series have been identified and separated, the remaining data not associated with the slowly varying oscillations may be set aside and considered residual. The residual data may then be decomposed further to identify and model the cyclical and known instantaneous disturbances, as well as the background stationary noise.

At operation 430, consistent with some embodiments discussed herein, the slowly varying oscillations estimated by means of the empirical mode decomposition method may be modeled using a cubic spline approximation. At operation 440, a prediction for the slowly varying oscillations may be obtained. In some embodiments, the prediction is obtained by first modeling the slowly varying oscillation data using cubic spline approximation, then extrapolating the slowly varying oscillation data further. For example a prediction based on the model may be made by simply extrapolating the data further, for example, by one day. A graph 500 representing the slowly varying oscillations extracted using empirical mode decomposition.

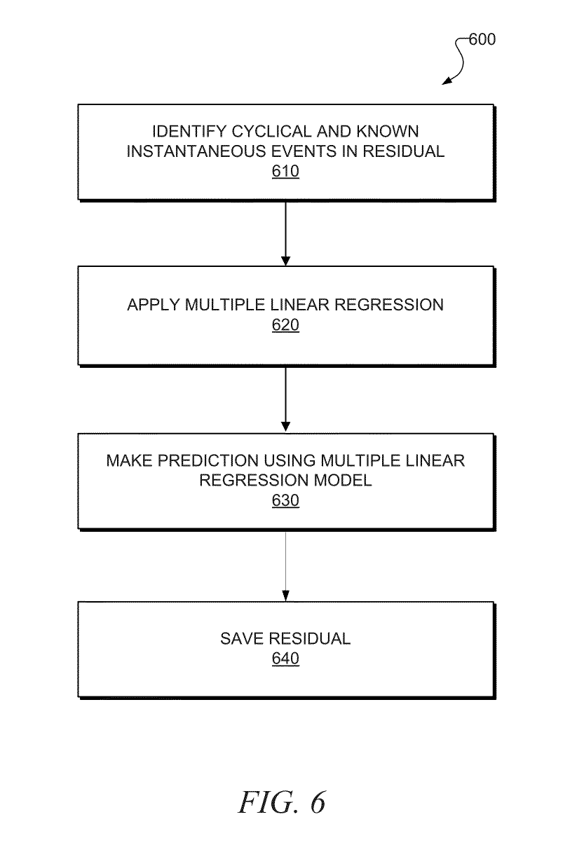

FIG. 6 presents a flowchart illustrating a method 600 for modeling and predicting the cyclical and known instantaneous disturbances from the residual component identified in FIG. 4, wherein the residual data represents the time series obtained by the source module 202 after the slowly varying oscillations have been removed. Data associated with instantaneous events are generally unpredictable and difficult to model, due to their non-stationarity, and the lack of information leading up to a particular event. In order to create an accurate prediction model for a time series, the instantaneous events should be separated and dealt with independently. Also, cyclical events are a type of events which can be extracted from the data as they are completely predictable.

In some embodiments, the decomposition module 203 may be configured such that known instantaneous events and cyclical events are identified and separated from the residual. By modeling the known instantaneous events, certain issues typically associated with the modeling of an unpredictable non-stationary time series may be avoided. Examples of such known instantaneous events in an online marketplace may include known holidays; promotional and marketing effects; and external incentives which may encourage particular non-stationary behaviors. The example of cyclical effects could be weekly and annual cycles. The cyclical and known instantaneous events module 223 may be configured to identify specific known events with corresponding attributes.

At operation 610, features associated with cyclical and known instantaneous events are selected from the residual. For example, for data representing total sales per day over a three-year period, the decomposition module 203 may be configured to locate data which has a known effect on total sales. In some embodiments, this may include data associated with a particular day of the week, holiday event, promotional event, weather event, sporting event, and the like, which may be associated with periodic and/or sudden increase or decrease in daily sales.

At operation 620, the cyclical and known instantaneous events are modeled with Multiple Linear Regression (MLR). For example, abrupt effects in retail market data, corresponding to religious, Thanksgiving and Christmas shopping, government, vacation, family, or partying may be modeled as instantaneous events with varying attributes. These attributes may include corresponding spending and purchasing habits, device usage, traffic to particular websites, and the like. The cyclical events can be modeled within the same regression model as the instantaneous events using the sinusoid and cosine terms with cycles of interest. In the case of daily retail data, we have modeled the weekly cycles and harmonics of it by day of the week control dummies. The data associated with the MLR model is then removed from the residual.

MLR may be used to fit a predictive model to an observed data set of X and y values. After developing such a model, if an additional value of X is given without its accompanying y value, or vice versa, the fitted model can be used to make a prediction of the missing value. At operation 630, a prediction may be made based on the MLR model of the data associated with the known instantaneous events and existing cycles. At operation 640, both the component representing slowly varying oscillations and the component representing the cyclical events and known instantaneous events having been removed, the remaining residual data may be considered stationary background noise.

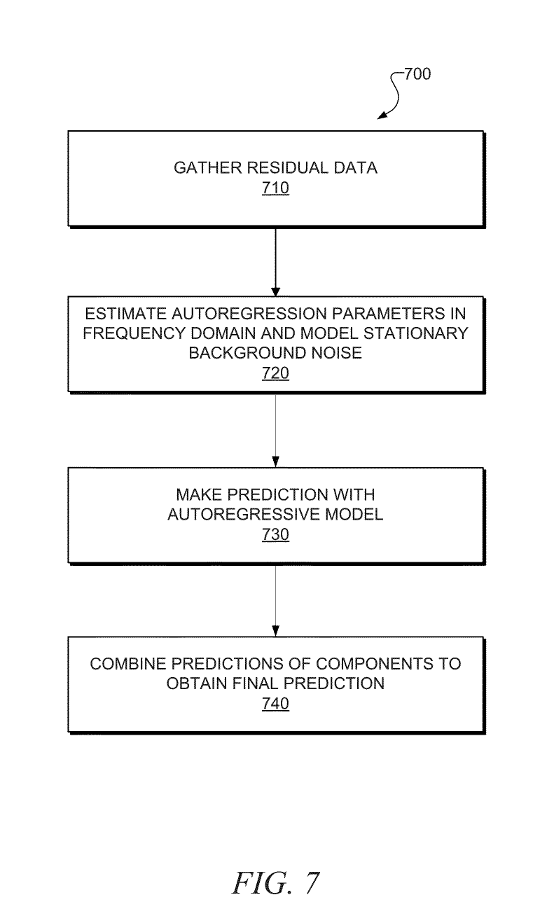

FIG. 7 presents a flowchart describing a method 700 for modeling and predicting stationary background noise in order to obtain a final prediction for a time series. An autoregressive model is a representation of a type of stationary process; as such, it may be used to describe certain time-varying processes. The autoregressive model specifies that the output variable depends linearly on its own previous values. At operation 710, the remaining residual data from operation 640 of FIG. 6 is gathered. In some embodiments, this data may be stationary background noise.

At operation 720, an autoregressive model is made with the background noise. As stated above, an autoregressive model specifies that the output depends in a linear form on its own previous value, wherein:

Yₜ=Σᵢ₌₁^{Q}αᵢYₜ₋ᵢ+εₜ

Where “α₁, α₂, α_{Q}” are the parameters of the autoregressive model and Eₜ is white noise. The parameters which must be estimated are Q and the coefficients α₁, ₂, . . . α_{Q}. A person of ordinary skill in the art would understand that there are a variety of techniques which may be used to estimate the coefficients α₁, α₂, α_{Q}. Most of these techniques are defined in a time domain, and often use an estimate of the auto-correlation function. Alternatively, and in some embodiments disclosed herein, frequency domain techniques may be used to estimate these coefficients. Reference is made to the following articles, which provide a more detailed description of the theory behind creating an autoregressive model and estimating coefficients in the frequency domain:
Bhansali, R. J. (1974) “Asymptotic Properties of the Wiener-Kolmogorov Predictor. (Part 1).” Journal of the Royal Statistical Society. Series B (Methodological), 36(1), 61-73.

Following the proposed method in the article above, an estimate of the spectrum of the underlying process using the given data is used to estimate the coefficients of this autoregressive model. The method used to estimate the spectrum is called multi-taper spectrum estimate. Reference is made to the following article which provides a more detailed description of the multi-taper spectrum estimation:
Thomson, D. J. (1982) “Spectrum estimation and harmonic analysis.” Proceedings of the IEEE, 70, 1055-1096.

Certain statistics associated with this spectrum estimation are used to develop a truncation method for the number of coefficients used in the AR model, e.g. an estimate for Q. This truncation method is described in the article
Thomson, D. J. (2000) “Multitaper analysis of non-stationary and nonlinear time series data.” In W. Fitzgerald, R. Smith, A. Walden, and P. Young, editors, Nonlinear and Non-stationary Signal Processing, pages 317-394. Cambridge Univ. Press, London, England.

At operation 730, a prediction is made for the stationary background noise using the autoregressive model. In some embodiments, at operation 740, once a prediction has been obtained for each of the three components of the decomposed time series, the model summation module 210 may obtain a final prediction for the time series by summing all of the component predictions.

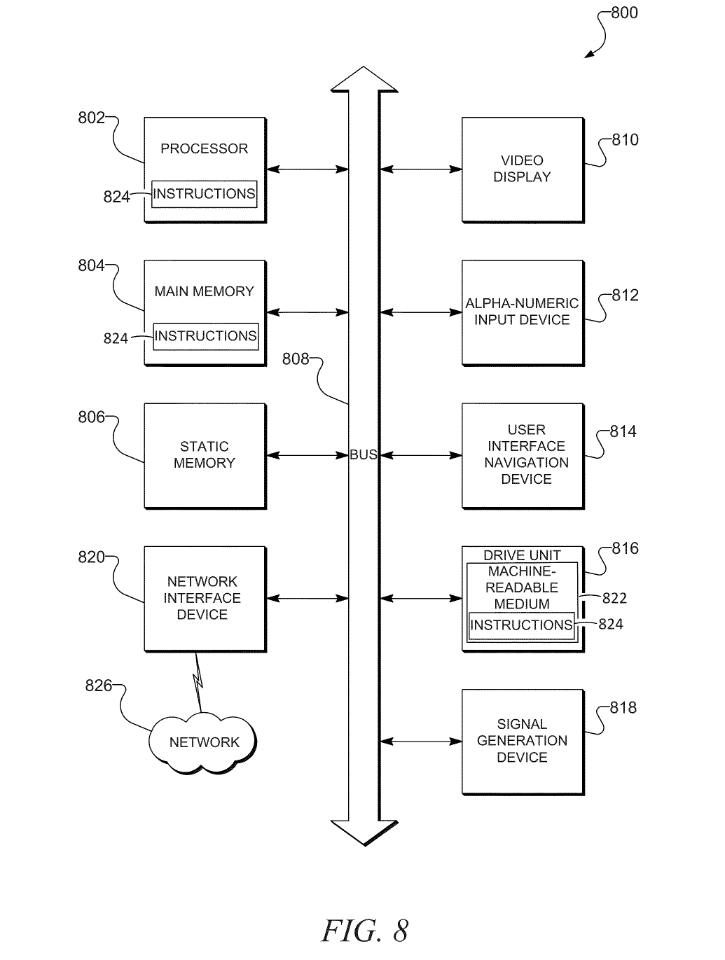

FIG. 8 is a block diagram of machine in the example form of a computer system 800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a drive unit 816, a signal generation device 818 (e.g., a speaker), and a network interface device 820.

### Machine Readable Medium

The disk drive unit 816 includes a machine-readable medium 822 on which is stored one or more sets of instructions (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies described herein, or that is capable of storing, encoding, or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
obtaining a time series, comprising real-world data over a specified period of time;
decomposing the time series into a superposition of a plurality of components;
for each one of the plurality of components, selecting a corresponding prediction algorithm;
generating a corresponding model for each of the plurality of components and the slowly varying oscillations;
extrapolating each of the corresponding models for each of the plurality of components in order to obtain a component prediction;
combining the component predictions of each of the plurality of components with the slowly varying oscillation component to generate a final prediction on the time series, representing predicted behavior of the online marketplace; and
presenting the final prediction.

2. The method of claim 1, wherein the plurality of components comprises a slowly varying oscillation component, a cyclical and known instantaneous disturbances component, and a stationary background noise component;
wherein the slowly varying oscillations components is automatically separated from the time series first, leaving a residual; and
the cyclical and known instantaneous disturbances component are identified and separated from the residual, leaving the stationary background noise.

3. The method of claim 2, wherein the slowly varying oscillations may be data associated with trends and seasonality.

4. The method of claim 2, wherein the cyclical and known instantaneous disturbances may be data associated with cycles, holiday effects, promotional effects, or the like.

5. The method of claim 2, wherein the separation of the slowly varying oscillation component is done automatically, and without manual tuning by an operator.

6. The method of claim 1, wherein the corresponding model for each of the plurality of components is generated based on the corresponding prediction algorithm.

7. The method of claim 2, wherein the corresponding model for the slowly varying oscillations is generated using empirical mode decomposition.

8. The method of claim 2, wherein the corresponding model for the cyclical and known instantaneous disturbances is obtained using Multiple Linear Regression.

9. The method of claim 2, wherein the component prediction for the stationary background noise is obtained with an autoregressive model having coefficients;
wherein the coefficients are estimated using frequency-domain techniques.

10. The method of claim 8, wherein features taken into consideration to model the cyclical and known instantaneous disturbances using the Multiple Linear Regression include:
a control for data associated with days of the week;
holiday data based on their type and attributes; and
promotional and marketing data.

11. The method of claim 1, wherein the final prediction corresponding to the time series is used for the purpose of anomaly detection.

12. The method of claim 1, wherein the final prediction is obtained through calculating a sum of the component predictions of each of the plurality of components of the time series.

13. A system for making a prediction based on a time series, comprising:
a machine having a memory and at least one processor; and
at least one module, executable by the at least one processor, comprising:
a source module, configured to obtain the time series;
a decomposition module, configured to decompose the time series into a superposition of a plurality of components;
an algorithm selection module, configured to select an appropriate prediction algorithm to apply to each of the plurality of components;
a modeling module, configured to model each of the components separately;
a prediction module, configured to extrapolate each model in order to obtain a component prediction;
a model summation module, configured to obtain a final prediction for the time series; and
a presentation module, configured to present the final prediction.

14. The system of claim 13, wherein the decomposition module may decompose the time series into a component associated with slowly varying oscillations, a component associated with cyclical and known instantaneous disturbances, and a component associated with a stationary background noise.

15. The system of claim 13, wherein the algorithm selection module may select the appropriate prediction algorithm for each of the plurality of components, based on one or more parameters of each of the plurality of components.

16. The system of claim 13, wherein the model generated by the modeling module is based on the corresponding prediction algorithm of each of the plurality of components.

17. The system of claim 13, wherein the final prediction is obtained through calculating a sum of the component predictions of each of the plurality of components of the time series.

18. A non-transitory machine-readable storage medium storing a set of instruction that, when executed by at least one processor, causes the at least one processor to perform a set of operations comprising:
obtaining a time series;
decomposing the residual into a superposition of a plurality of components;
selecting a corresponding prediction algorithm to apply to each of the plurality of components based on one or more parameters of the corresponding component;
generating a corresponding model for each of the plurality of components and the slowly varying oscillation component, based on the corresponding prediction algorithm;
extrapolating each of the corresponding models for each of the plurality of components in order to obtain a component prediction;
combining the component predictions for each of the plurality of components and the slowly varying oscillation component to create a final prediction for the time series; and
presenting the final prediction.

19. The non-transitory machine-readable storage medium of claim 18, the superposition of a plurality of components comprises a slowly varying oscillation component, a cyclical and known instantaneous disturbances component, and a stationary background noise component;
wherein the slowly varying oscillations components is separated from the time series first, leaving a residual; and
the cyclical and known instantaneous disturbances component are identified and separated from the residual, leaving the stationary background noise.

20. The non-transitory machine-readable storage medium of claim 18, storing a set of instruction that, when executed by at least one processor, causes the at least one processor to decompose the time series into the plurality of components automatically and without manual tuning and operator oversight.
